(19) United States
(12) Patent Application Publication
(10) Pub. No.: US 2021/0355974 A1
(43) Pub. Date: Nov. 18, 2021

(54) CONDUIT ADAPTOR FOR PUMP DISPENSER

(71) Applicant: CANYON CORPORATION, Tokyo (JP)

(72) Inventor: Mitsuaki SHAZUKI, Sanyo Onoda-shi, Yamaguchi (JP)

(21) Appl. No.: 17/274,112

(22) PCT Filed: Sep. 5, 2019
(86) PCT No.: PCT/JP2019/035083

§ 371 Date: Mar. 5, 2021

(30) Foreign Application Priority Data
Sep. 12, 2018 (JP) 2018-170791

(51) Int. Cl. F15D 1/02; B05B 15/30

(52) U.S. Cl. CPC F15D 1/025; B05B 15/30

(57) ABSTRACT

[Object] To provide a pump dispenser that makes it possible to prevent air from entering a conduit even in a case where there is little liquid left in a vessel and prevent back-flow drippage of the liquid from the conduit even in a case where the pump dispenser has been removed from the vessel.

[Solution] An adaptor A that is attached to a pump dispenser B configured to suck up liquid out of a vessel via a conduit 3 and eject the liquid from a nozzle includes a tubular portion 1 that is attachable to the conduit 3 and that has an opening in an upper part thereof and a bottom wall portion 11 forming the bottom of the tubular portion 1. The bottom wall portion 11 includes an outlet hole 2, and the diameter ER of the outlet hole is smaller than the inner diameter TR of the conduit.

### TECHNICAL FIELD

The present invention relates to conduit adapters for pump dispensers and, more particularly, to a conduit adapter for a pump dispenser that makes it possible to prevent back-flow drippage of liquid and prevent entrance of air.

### BACKGROUND ART

Pump dispensers are used for spraying various types of liquid.

These are intended to spray liquid contained in a vessel outward via a nozzle by applying pressure to the liquid with a piston through operation of a trigger and drawing the liquid into a cylinder through a conduit (see, for example, PTLs 1 and 2).

When there is little liquid left in the vessel and no more liquid can be drawn into the piston, the dispenser can be removed from the vessel for reuse by replenishing the vessel with liquid or replacing the vessel with a vessel filled with liquid.

### CITATION LIST

### Patent Literature

PTL 1: Japanese Patent Application Laid-Open No. 2017-13008

PTL 2: Japanese Patent Application Laid-Open No. 2017-937

### SUMMARY OF INVENTION

### Technical Problem

Incidentally, a pump dispenser is intended to suck up liquid through a conduit having its lower end in the liquid.

In this case, when the lower end of the conduit is in the liquid but the surface of the liquid is close to the lower end, there occurs a phenomenon in which the height of the liquid around the conduit drops under negative pressure and the lower end of the conduit becomes exposed to the air.

This causes the air to enter the conduit, thus hindering uniform spraying of the liquid from a nozzle (entrance-of-air problem).

Usually, since the lower end of the conduit is placed as close as possible to a bottom surface of the vessel, such a phenomenon tends to occur in a state in which there is little liquid left and the height of the liquid has come close to the bottom surface.

Meanwhile, in a case where there is little liquid left in the vessel or the vessel has run out of the liquid, an operation of removing the pump dispenser from the vessel and replenishing the vessel with liquid or replacing the vessel is performed.

In such a case, liquid remaining in the conduit of the pump dispenser thus removed may flow back and drip from the lower end of the conduit and contaminate its surrounding (back-flow drippage problem).

Moreover, further problems arise during later use.

That is, when the liquid in the conduit flows out by back-flow drippage, the air enters the conduit accordingly; therefore, when this pump dispenser is attached to the vessel for reuse, the liquid cannot be sprayed unless the air is purged from the conduit by making several air shots.

The present invention was developed to solve the aforementioned problems.

That is, the present invention has as an object to provide a pump dispenser that makes it possible to prevent air from entering a conduit even in a case where there is little liquid left in a vessel and prevent back-flow drippage of the liquid from the conduit even in a case where the pump dispenser has been removed from the vessel.

### Solution to Problems

The inventor diligently studied to solve the foregoing problems, found that the attachment to a lower end of the conduit an adaptor having an outlet hole whose diameter is smaller than the inner diameter of the conduit prevents air from entering through the conduit even in a case where there is little liquid left and that even in a case where the pump dispenser has been removed from the vessel, drippage of the liquid is prevented by holding the liquid in the conduit by effecting surface tension sufficient to retain the liquid at the surface of the liquid at the lower end of the conduit, and, based on these findings, accomplished the present invention.

The present invention is directed to (1) an adaptor A that is attached to a pump dispenser B configured to suck up liquid out of a vessel via a conduit 3 and eject the liquid from a nozzle 5, the adaptor including: a tubular portion 1 that is attachable to the conduit 3 and that has an opening in an upper part thereof; and a bottom wall portion 11 forming a bottom of the tubular portion 1, wherein the bottom wall portion 11 includes an outlet hole 2, and a diameter ER of the outlet hole is smaller than an inner diameter TR of the conduit 3.

The present invention is directed to (2) the adaptor A according to (1) described above, wherein an inner diameter of the tubular portion 1 becomes gradually larger toward an inlet.

The present invention is directed to (3) the adaptor A according to (1) described above, wherein the bottom wall portion 11 is great in wall thickness and has a lower surface formed aslant.

The present invention is directed to (4) the adaptor A according to any one of (1) to (3) described above, wherein a ratio of a diameter ER of the outlet hole to an inner diameter TR of the conduit is 0.3≤ER/TR≤0.7.

The present invention is directed to (5) the adaptor A according to (1) to (4) described above, wherein the tubular portion 1 is attached to a lower end of the conduit 3 by press fitting.

The present invention is directed to (6) the adaptor A according to any one of (1) to (5) described above, wherein the tubular portion 1 is higher in rigidity than the conduit 3.

The present invention is directed to (7) a pump dispenser B to which the adaptor A according to any one of (1) to (6) described above is attached.

### Advantageous Effects of Invention

Since the present invention is directed to an adaptor that is attached to a pump dispenser configured to suck up liquid out of a vessel via a conduit and eject the liquid from a nozzle, the adaptor including: a tubular portion that is attachable to the conduit; and a bottom wall portion, wherein the bottom wall portion includes an outlet hole, and a diameter of the outlet hole is smaller than an inner diameter of the conduit, the present invention makes it possible to prevent air from entering the conduit even in a case where there is little liquid left, thereby enabling uniform spraying of the liquid from the nozzle.

Further, in a case where the dispenser has been removed from the vessel, the surface tension of the liquid in the outlet hole of the adaptor is effected to such a more sufficient extent as to retain the liquid than the surface tension of liquid in a conduit including no adaptor.

As a result, the liquid in the conduit does not flow back or drip and does not make its surrounding dirty.

In the present invention, the inner diameter of the tubular portion becomes gradually larger toward the opening. This makes it easy to position the conduit in the tubular portion, making it easy to attach the adaptor.

In the present invention, the bottom wall portion is great in wall thickness and has a lower surface formed aslant. This makes it possible to, in the case of a conduit of a pump dispenser having its lower part bent, suck up the liquid into the conduit until the level of the liquid in the vessel becomes as low as possible, making it possible to efficiently use up the liquid.

In the present invention, the ratio of the diameter ER of the outlet hole to the inner diameter TR of the conduit is 0.3≤ER/TR≤0.7. This makes it possible to sufficiently prevent air from entering the conduit and makes it possible to sufficiently ensure effective surface tension.

In the present invention, the tubular portion is attached to the lower end of the conduit by press fitting. This makes it easy to attach and fix the adaptor to the conduit.

In the present invention, the tubular portion is higher in rigidity than the conduit. This makes it easy to attach the adaptor to the conduit.

Further, since the adaptor is high in rigidity, the shape of the lower end of the conduit is maintained without being deformed.

Since the present invention is directed to a pump dispenser to which the adaptor is attached, the present invention can bring about each of the aforementioned effects.

### BRIEF DESCRIPTION OF DRAWINGS

FIG. 1 illustrates a longitudinal sectional view (A) and a perspective view (B) of an adaptor that is attached to a pump dispenser.

FIG. 2 is a longitudinal sectional view showing a pump dispenser attached to a vessel.

FIG. 3 is a longitudinal sectional view of the pump dispenser of FIG. 2 with the adaptor attached to a conduit of the pump dispenser.

FIG. 4 illustrates diagrams (A) and (B) explaining principles according to which in a state in which the height of liquid in the vessel has dropped close to a bottom surface of the vessel, the liquid is drawn into the conduit, (A) showing a case where the adaptor is attached to the conduit, (B) showing a case where the adaptor is not attached to the conduit.

FIG. 5 illustrates longitudinal sectional views (A) and (B) of a state in which the pump dispenser has been removed from the vessel, (A) showing a case where the adaptor A is attached to the conduit, (B) showing a case where the adaptor A is not attached to the conduit.

FIG. 6 illustrates a longitudinal sectional view (A) and a plan view (B) of an adaptor according to a second embodiment.

FIG. 7 is a longitudinal sectional view of a pump dispenser having a conduit, bent in the middle, to which the adaptor of the second embodiment is attached.

FIG. 8 is a longitudinal sectional view showing the pump dispenser with no adaptor attached to the bent conduit of FIG. 7.

### DESCRIPTION OF EMBODIMENTS

The following describes preferred embodiments of the present invention in detail with reference to the drawings as needed.

It should be noted that identical elements are given identical signs throughout the drawings and a repeated description of such elements is omitted.

Further, positional relationships such as top, bottom, left, and right are based on positional relationships shown in the drawings, unless otherwise noted.

Furthermore, the ratios of dimensions in the drawings are not limited to the ratios illustrated.

The following describes a first embodiment.

The present invention is directed to an adaptor that is attached to a pump dispenser configured to suck up liquid out of a vessel via a conduit and eject the liquid from a nozzle.

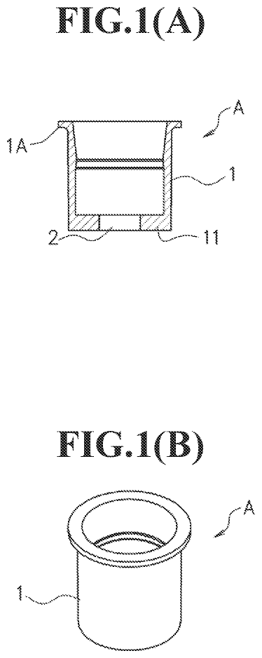

FIG. 1 illustrates a longitudinal sectional view (A) and a perspective view (B) of an adaptor A that is attached to a pump dispenser.

The adaptor A is attachable to a lower end of a conduit 3 of a pump dispenser B, and can be easily fixed by press fitting from the outside.

This adaptor A includes a tubular portion 1 and a base wall portion 11.

In particular, the tubular portion 1, which has a cylindrical shape, has an opening in an upper part thereof, and at the bottom of the tubular portion 1, the bottom wall portion 11 is formed.

Moreover, the bottom wall portion 11 has an outlet hole 2 bored through the center thereof, and the thickness of the bottom wall portion 11 is as thin as that of a side wall.

The tubular portion 1 has a flange portion 1A formed at an upper end thereof, and this portion serves as a finger grip by which the adaptor A is held in a case where the adaptor A is press-fitted onto the conduit 3.

Further, the inner diameter of the tubular portion 1 becomes larger toward the opening so that the adaptor A is easily fitted onto the conduit 3.

The diameter of the outlet hole 2 of the bottom wall portion 11 of the adaptor A is smaller than the inner diameter of the conduit 3.

Note here that from the point of view of entrance of air and the point of view of surface tension, it is preferable that a relationship between the diameter ER of the outlet hole 2 of the adaptor A and the inner diameter TR of the conduit 3 of the pump dispenser B be set to satisfy 0.3≤ER/TR≤0.7.

For example, when the inner diameter TR of the conduit 3 is 9 mm, the diameter ER of the outlet hole 2 of the adaptor A is 6 mm, or when the inner diameter TR of the conduit 3 is 12 mm, the diameter ER of the outlet hole 2 of the adaptor is 5 mm.

In terms of the “entrance-of-air problem” mentioned earlier, since the diameter ER of the outlet hole 2 of the bottom wall portion 11 is smaller than the inner diameter TR of the conduit 3, the velocity of flow of liquid W that is drawn into the conduit 3 decreases even in a state in which a lower end of the conduit 3 is in the liquid and the surface of the liquid is close to the lower end. This makes it possible to minimize a drop in the height of the liquid around the conduit 3 and effectively prevent air X from entering the conduit (prevention of entrance of air).

Of course, entrance of the air X can be similarly prevented even in a state in which there is little liquid left in a vessel and the height of the liquid has dropped close to a bottom surface of the vessel.

In this way, the entrance-of-air problem is overcome.

Further, in terms of the “back-flow drippage problem” mentioned earlier, since the diameter ER of the outlet hole 2 of the bottom wall portion 11 is smaller than the inner diameter TR of the conduit 3, the diameter of the surface of the liquid in the outlet hole 2 of the adaptor A becomes smaller than the inner diameter TR of the conduit 3 and surface tension becomes greater than a gravitational force acting on the liquid W when the pump dispenser B has been removed from a vessel 4, so that the liquid W can be retained in the conduit 3.

This makes it possible to maintain a state in which the conduit is filled and the liquid W in the conduit is prevented from flowing back or dripping (prevention of back-flow drippage) to make its surrounding dirty.

Moreover, since the liquid W does not flow back or drip, no air enters the conduit 3, and it is not necessary to purge air from the conduit by bothering to make an air shot in using the vessel 4 again after replenishing the vessel 4 with liquid.

In this way, the back-flow drippage problem is overcome.

This brings about great improvement in usability of the pump dispenser B.

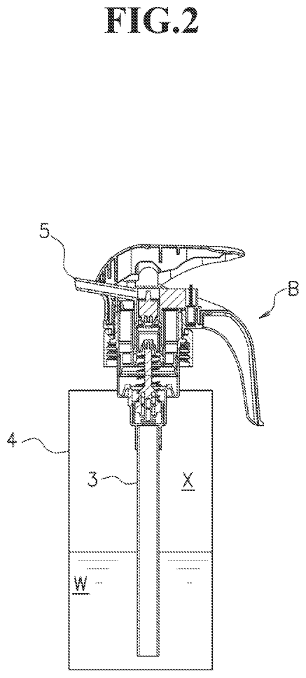

FIG. 2 is a longitudinal sectional view showing a pump dispenser B attached to a vessel 4.

The pump dispenser B includes a trigger for operation, a piston interlocked with the trigger, a cylinder including the piston, a vessel 4 for holding liquid W, a conduit 3 having its lower end inserted in the vessel 4, a nozzle 5 that sprays the liquid W outward, an F valve that opens and closes a flow passage between the conduit 3 and the cylinder, an S valve that opens and closes a flow passage between the cylinder and the nozzle 5, or other components.

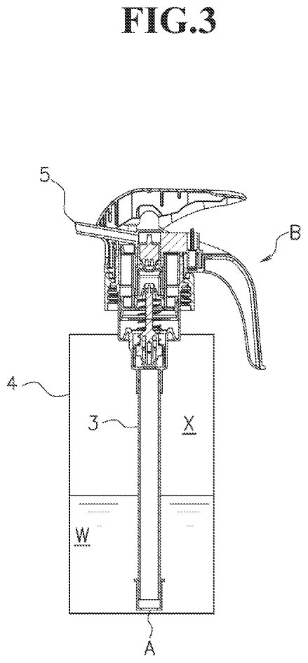

FIG. 3 is a longitudinal sectional view of the pump dispenser B of FIG. 2 with an adaptor A attached to the conduit 3 of the pump dispenser B.

In a case where the adaptor A is attached to the lower end of the conduit 3, the bottom wall portion 11 of the adaptor A is pressed into contact with the lower end of the conduit 3, whereby the adaptor A is always attached at the same position.

As mentioned earlier, press fitting is preferably used for attaching and fixing the adaptor A to the conduit 3, and this makes it easy to perform assembling.

Note here that it is preferable that the adaptor A be made of a material which is higher in rigidity than that of which the conduit 3 is made.

For example, the conduit 3 is made of polyethylene, and the adaptor A is made of polypropylene.

Since the adaptor A is attached to the conduit 3 by being fitted onto the conduit 3, the lower end of the conduit 3 is protected and does not deform.

This effect is remarkable especially in a case where the tubular portion 1 of the adaptor A is higher in rigidity than the conduit 3.

By the way, an exposed lower end of a conventional conduit 3 has had the drawback of forming a narrower passage by being deformed or crushed after a long period of use.

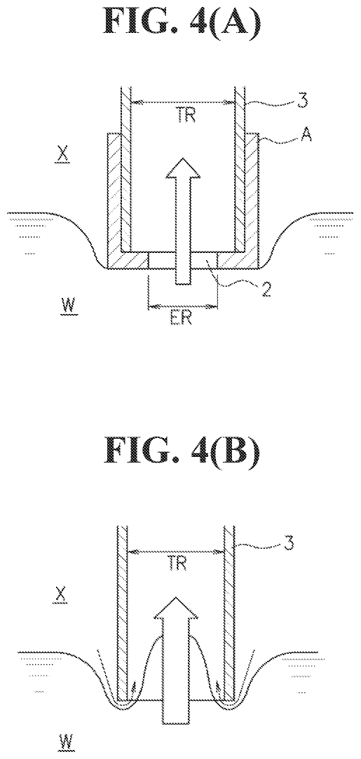

FIG. 4 illustrates diagrams (A) and (B) explaining principles according to which in a state in which the height of liquid in the vessel has dropped close to a bottom surface of the vessel, the liquid W is drawn into the conduit.

FIG. 4(A) shows a case where the adaptor A is attached to the conduit 3, and FIG. 4(B) shows a case where the adaptor A is not attached to the conduit 3.

Performing an operation of pulling the trigger of the pump dispenser B causes the piston to move to make pressure in the cylinder negative, so that the F vale opens.

This negative pressure causes the liquid W to be drawn out of the vessel 4 into the conduit.

In this case, if the surface of the liquid is close to the lower end of the conduit 3, the liquid W that is sucked into the conduit 3 as shown in FIG. 4(B) causes the height of the liquid around the conduit 3 to drop and causes the lower end of the conduit to be exposed to the air, with the result that air X enters the conduit.

However, in a case where the adaptor A is attached to the conduit 3 of the pump dispenser B, there is an increase in resistance since the diameter ER of the outlet hole 2 of the adaptor A is smaller than the inner diameter TR of the conduit 3, so that the velocity of flow of the liquid W that is sucked into the conduit decreases.

This makes it possible to suppress the drop in the height of the liquid around the conduit 3 and prevent entrance of the air X.

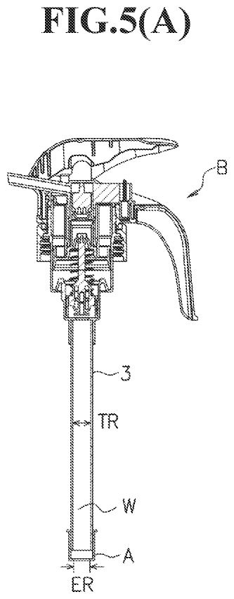

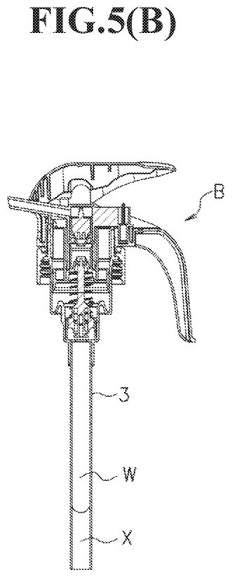

FIG. 5 illustrates longitudinal sectional views (A) and (B) of a state in which the pump dispenser B has been removed from the vessel 4.

FIG. 5(A) shows a case where the adaptor A is attached to the conduit 3, and FIG. 5(B) shows a case where the adaptor A is not attached to the conduit 3.

In a case where there is little liquid W left in the vessel 4 and the vessel 4 needs to be replenished with liquid W or replaced, the pump dispenser B is removed from the vessel 4.

In this state, liquid W sucked up during use of the pump dispenser B remains in the conduit.

However, in a case where the adaptor is not attached as shown in FIG. 5(B), surface tension is weak as compared with the weight of the liquid W since the inner diameter TR of the end of the conduit 3 is larger, so that the liquid W is drained from the conduit 3 by flowing back and dripping.

As a result, the air X enters the area from which the liquid W was drained.

Therefore, as mentioned above, in a case where the pump dispenser B is attached to the vessel, it is necessary to make an air shot before use to purge the air X from the conduit, resulting in poor usability.

In particular, removal of the pump dispenser B from the vessel 4 entails a touch of air on the lower end of conduit 3.

In this case, surface tension is acting on the liquid W in the conduit, but when this surface tension is less than the gravitational force acting on the liquid W, the aforementioned problems such as back-flow drippage of the liquid W arise.

Meanwhile, in a case where the adaptor A is attached to the conduit 3 of the pump dispenser B as shown in FIG. 5(A), the surface tension becomes greater than the gravitational force acting on the liquid W as compared with a case where the adaptor A is not attached to the conduit 3, so that the liquid W can be retained at the surface of the liquid at the lower end of the conduit 3, as the diameter of the outlet hole 2 of the adaptor A is smaller than the inner diameter TR of the conduit 3.

This makes it possible to prevent back-flow drippage of the liquid W as much as possible even in a case where the lower end of the conduit 3 is exposed to the air.

This eliminates the need for an air shot operation to purge the air X in using the pump dispenser B next time, bringing about improvement in usability.

Of course, the liquid W no longer drips or contaminates its surroundings.

Next, a second embodiment is described.

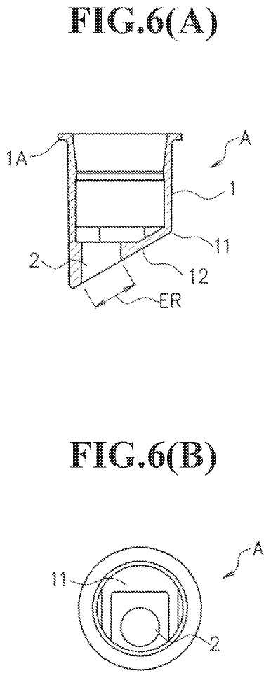

FIG. 6 illustrates a longitudinal sectional view (A) and a plan view (B) of an adaptor A according to the second embodiment.

As with the first embodiment, the adaptor A according to this second embodiment is attached to a lower end of a conduit 3 of a pump dispenser B.

Moreover, this adaptor A can be easily attached by being press-fitted onto the lower end of the conduit 3.

This adaptor A includes a tubular portion 1 having an opening in an upper part thereof and a bottom wall portion 11 forming the bottom of the tubular portion, and the bottom wall portion includes an outlet hole 2.

Moreover, the diameter ER of the outlet hole 2 of the bottom wall portion 11 is smaller than the inner diameter TR of the conduit 3.

In this second embodiment, too, the inner diameter of the tubular portion 1 becomes gradually larger toward an inlet so that the adaptor A is easily attached to the conduit 3.

The present embodiment differs from the first embodiment in that whereas the wall thickness of the bottom wall portion 11 of the first embodiment is substantially the same as the thickness of the side wall of the tubular body 1, the wall thickness of the bottom wall portion 11 of the present embodiment is much greater than the thickness of the side wall of the tubular body 1.

Furthermore, in the present embodiment, the bottom wall portion 11 has its lower surface formed into a slope 12 as if it were cut off aslant.

The adaptor A of this second embodiment has great merit in being attached to a conduit 3 bent in the middle in a vessel.

By the way, in the case of a pump dispenser B that is aimed obliquely downward for use most of the time, such a bent conduit 3 is often used.

The attachment of the adaptor A makes it possible to prevent air X from entering the conduit even in a state in which the height of liquid in the vessel has dropped close to a bottom surface of the vessel (prevention of entrance of air).

Further, as compared with a case where the adaptor A is not attached, the surface tension of liquid W in the outlet hole 2 is effected to such a sufficient extent as to retain the liquid W even in a case where the pump dispenser B has been removed from a vessel 4, so that back-flow drippage of the liquid W out of the conduit can be prevented (prevention of back-flow drippage).

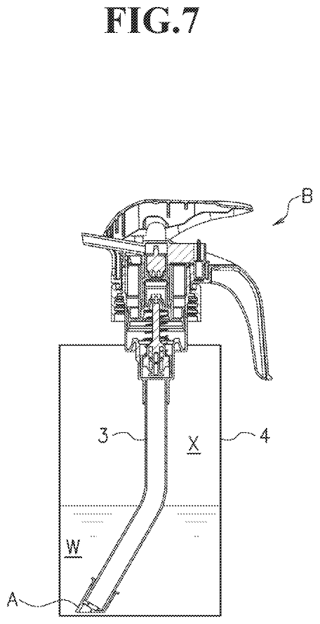

FIG. 7 is a longitudinal sectional view of a pump dispenser B having a conduit 3, bent in the middle, to which the adaptor A of the second embodiment is attached.

The adaptor A according to the second embodiment is attached to a lower end of the conduit 3.

The slope 12 of the adaptor A, which is attached to the lower end of the conduit 3, is facing directly downward. That is, the outlet hole 2 is facing directly upward.

As a result, even in a case where the surface of the liquid W in the vessel 4 has dropped close to the bottom surface of the vessel, the slope 12 of the adaptor A is parallel to the surface of the liquid, so that the liquid can be maximally used up (use-up effect).

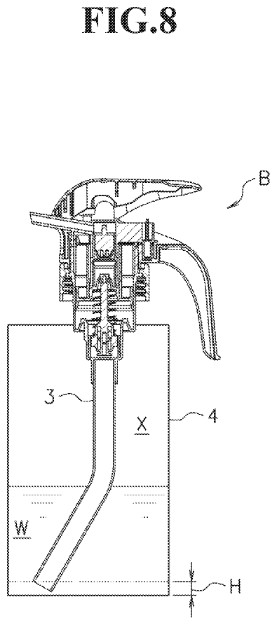

For reference, FIG. 8 is a longitudinal sectional view showing the pump dispenser B with no adaptor A attached to the bent conduit 3 of FIG. 7.

In this case, a part of the lower end of the conduit 3 is exposed to the air in a state in which the height of the liquid has dropped to a position (i.e. a height H) close to the bottom surface, with the result that not the liquid W but the air X is sucked into the conduit.

This makes it impossible to use up liquid present at or below the height H in the vessel.

In this second embodiment 2, too, the inner diameter of the tubular portion 1 becomes gradually larger toward an inlet so that the adaptor A is easily attached to the conduit 3.

An adaptor A of the present invention can sufficiently bring about the aforementioned effects and can be versatilely used simply by being attached to an existing pump dispenser B.

In the foregoing, preferred embodiments of the present invention have been described. However, the present invention is not limited to the foregoing embodiments.

The shape of the flange portion 1A formed at the upper end of the tubular body 1 needs only be an easy-to-hold shape, and the flange portion 1A is not necessarily needed.

The adaptor A and the conduit 3 can be integrally formed. In that case, the adaptor A and the conduit 3 can be made of separate materials by two-color molding.

### INDUSTRIAL APPLICABILITY

The present invention can prevent entrance of air and back-flow drippage by being attached to a conduit, and is widely applicable to various types of pump dispenser for household use and professional use.

### REFERENCE SIGNS LIST

A . . . adaptor,
B . . . pump dispenser,
1 . . . tubular portion,
1A . . . flange portion,
11 . . . bottom wall portion,
12 . . . slope,
2 . . . outlet hole,
3 . . . conduit,
4 . . . vessel,
5 . . . nozzle,
ER . . . diameter of outlet hole,
TR . . . inner diameter of conduit,
W . . . liquid,
X . . . air

1. An adaptor that is attached to a pump dispenser configured to suck up liquid out of a vessel via a conduit and eject the liquid from a nozzle, the adaptor comprising:
a tubular portion that is attachable to the conduit and that has an opening in an upper part thereof; and
a bottom wall portion forming a bottom of the tubular portion,
wherein
the bottom wall portion includes an outlet hole, and
a diameter of the outlet hole is smaller than an inner diameter of the conduit.

2. The adaptor according to claim 1, wherein an inner diameter of the tubular portion becomes gradually larger toward an inlet.

3. The adaptor according to claim 1, wherein the bottom wall portion is great in wall thickness and has a lower surface formed aslant.

4. The adaptor according to claim 1, wherein a ratio of a diameter ER of the outlet hole to an inner diameter TR of the conduit is 0.3≤ER/TR≤0.7.

5. The adaptor according to claim 1, wherein the tubular portion is attached to a lower end of the conduit by press fitting.

6. The adaptor according to claim 1, wherein the tubular portion is higher in rigidity than the conduit.

7. A pump dispenser to which the adaptor according to claim 1 is attached.
